(19) United States
(12) Patent Application Publication
(10) Pub. No.: US 2023/0166240 A1
(43) Pub. Date: Jun. 1, 2023

(54) METHOD FOR PRODUCING CATALYSTS USING 3D PRINTING TECHNOLOGY

(71) Applicant: Clariant International Ltd, Muttenz (CH)

(72) Inventors: Stephan J. REITMEIER, Kirchseeon (DE); Markus TONIGOLD, Holzkirchen (DE); Rene ECKERT, Bad Aibling (DE)

(21) Appl. No.: 17/921,132

(22) PCT Filed: Apr. 21, 2021
(86) PCT No.: PCT/EP2021/060370

§ 371 Date: Oct. 25, 2022

(30) Foreign Application Priority Data
May 7, 2020 (DE) 10 2020 112 372.8

(51) Int. Cl. B01J 23/745; B22F 10/28; B01J 35/10; C01C 1/04; C10G 2/00

(52) U.S. Cl. CPC B01J 23/745; B22F 10/28; B01J 35/1047; C01C 1/0411; C10G 2/332; B22F 2998/10; B22F 2302/25; B33Y 10/00

(57) ABSTRACT

The invention relates to a method for producing iron-containing shaped catalyst bodies by means of 3D printing technology and to iron-containing shaped catalyst bodies that are obtainable by this method and to their use as catalysts in the ammonia synthesis or the Fischer-Tropsch reaction.

Heterogeneous catalysts based on iron are employed industrially in numerous chemical reactions, such as in ammonia synthesis or Fischer-Tropsch reaction, for example.

The synthesis of ammonia from the elements hydrogen and nitrogen represents an important large-scale industrial application which can be used to obtain important nitrogen-containing derivatives, especially fertilizers. The primarily employed method established in this context is the Haber-Bosch process.

For other sectors as well, such as for energy storage (“power-to-ammonia”), ammonia constitutes an important building block.

The catalysts selected for use for ammonia synthesis are predominantly based on iron catalysts. The iron in these catalysts is customarily in the form of magnetite or wuestite, the catalysts being additionally promoted with further elements. Thus, U.S. Pat. No. 5,846,507 describes the production of an ammonia catalyst whose main phase is wuestite and which has been obtained by the melting of iron and magnetite in a resistance furnace.

The catalysts are produced industrially by melting the constituent substances of the catalyst in the form of a mixture in an arc furnace or resistance furnace, and cooling and pelletizing the resultant melt (Ullmann's Encyclopedia of Industrial Chemistry, 2006, section 4.4.1.3., pages 35-36). This requires high energies, and is only able to generate pellets with a compact structure.

The generation of ordered structures by means of 3D printing techniques in the sector of catalyst production has been known for a number of years. Printed here typically are support structures, which are subsequently loaded with catalytically active components in a conventional way. Illustrative reference may be made here to EP 2 200 736 B1.

WO 2012/032325 A1 describes a method for producing a catalyst using an additive layer method, in which a layer of a pulverulent catalyst or catalyst support material is formed, the powder in this layer is subsequently melted or bonded in accordance with a predetermined pattern, and these steps are repeated until a shaped unit is formed, to which optionally a catalytic material is applied.

3D printing technologies include methods such as rapid prototyping (RP). This method has since been realized through various technologies such as selective laser sintering (SLS), electron beam melting (EBM) or stereolithography (SLA), there being numerous publications describing the fields of use, materials employable and specific operational steps in these technologies.

There continued to be a need for improved iron-containing catalysts, particularly for ammonia synthesis, which are notable for shaped body geometries which are not accessible via the methods employed in the prior art.

There was also a need for a method for producing iron-containing catalysts, particularly for ammonia synthesis, with which it is possible to obtain shaped body geometries which are not accessible through the methods employed in the prior art.

This object is achieved by a method in which the iron-containing shaped catalyst body is obtained by means of 3D printing technology, and also by the shaped catalyst body which is obtainable with this method.

A subject of the present invention, therefore, is a method for producing iron-containing shaped catalyst bodies, characterized in that the individual components are connected to one another by means of 3D printing technology.

The method comprises the following steps:
a) applying a pulverulent starting material or starting material mixture comprising at least one iron compound in a thin layer to a base,
b) subsequently irradiating this layer at selected sites so that the powder at these sites becomes connected, thereby connecting the individual powder particles to one another,
c) removing the unconnected powder, so that the connected powder remains in the form of the shaped catalyst body.

In a preferred embodiment the method steps a) and b) are repeated until the desired shaped body has been constructed completely from the individual layers. In this case the method is characterized by the following steps:
a) applying a pulverulent starting material or starting material mixture comprising at least one iron compound in a thin layer to a base,
b) subsequently irradiating this layer at selected sites so that the powder particles are connected to one another,
b1) repeating steps a) and b) until the shape of the shaped catalyst body has formed,
c) removing the unconnected powder, so that the connected powder remains in the form of the shaped catalyst body.

With this method it is possible to generate shaped catalyst bodies having different geometries. Illustrative embodiments are pellets, beads, cylinders, rings, honeycombs or spoked wheels.

Suitable iron compounds in this context are in principle all iron compounds having an iron oxidation state of II and/or III and also, moreover, iron in an oxidation state of 0. Preferred compounds are Fe₁₋ₓO (with 0<x<⅓), FeO, Fe₂O₃, Fe₃O₄ and Fe or mixtures thereof.

In a preferred embodiment a mixture of Fe in oxidation state 0 and FeO, Fe₂O₃ or Fe₃O₄, preferably a mixture of Fe and Fe₃O₄, is used. In this case step b) of the method of the invention is characterized in that the iron compounds contained in the mixture are transformed at least partially into other iron compounds. In one preferred embodiment Fe(0) and Fe₃O₄ in the form of magnetite are transformed at least partially into wuestite; the fraction of wuestite in the shaped catalyst body obtained, based on the total fraction of iron compounds, is at least 80 wt %, more preferably at least 90 wt % and very preferably 100 wt %.

Wuestite is an iron compound having the empirical formula Fe₁₋ₓO, where x can adopt values from 0 to ⅓, x being customarily between 0.05 and 0.17.

Under the production conditions, the mixture of the iron compounds is transformed into the catalytically active form or precursor thereof. More preferably the catalyst precursor is a compound containing wuestite that is converted into Fe(0) in the reactor by reduction, customarily with hydrogen.

In one embodiment the weight ratio of Fe(0) to the compound Fe₁₋ₓO, FeO, Fe₂O₃ or Fe₃O₄ in the mixture is in the range from 0.1 to 0.5, preferably 0.25 to 0.4. In a preferred embodiment a mixture of Fe(0) and Fe₃O₄ in the form of magnetite is used in which the weight ratio of Fe(0) to Fe₃O₄ is in the range from 0.1 to 0.5, preferably 0.25 to 0.4.

The powders used customarily have a mean arithmetic diameter of 1 to 100 pm. Preferably they have values of 4 to 85 μm, preferably of 10 to 60 μm.

The layers applied in step a) in the method of the invention customarily have layer thicknesses of at least 0.01 mm, preferably 0.04 mm. The layer thicknesses are customarily up to 2.00 mm, preferably up to 1.00 mm, more preferably up to 0.20 mm. In one embodiment the layer thicknesses range from 0.01 mm to 2.00 mm, preferably in the range from 0.04 mm to 1.00 mm, more preferably in the range from 0.04 to 0.20 mm.

Further to the iron compounds there may additionally be suitable promoter compounds present in the starting material or starting material mixture. These customarily are compounds of the elements K, Ti, V, Al, Mg, Ca or Cu. Preferred compounds are those of the elements K, Ti, V, Al, Mg or Ca.

Furthermore, auxiliaries such as binder materials or burnout substances may be admixed to the starting material or starting material mixture in step a). The fraction of these compounds is customarily less than 10 wt %, based on the weight of the starting material or starting material mixture. In one embodiment the starting material or starting material is introduced in step a) in the absence of these auxiliaries.

The irradiation in step b) takes place in the way known in 3D printing. Customarily here an electron beam or laser beam is used, which is directed at the selected site and which on the basis of the energy exposure on the one hand ensures transformation of the iron-containing mixture present into the catalytically active structure, and on the other hand at the same time causes the shaped body to form as well. Employed predominantly for this purpose at present are ytterbium fiber lasers, which are operated with a wavelength of 1070 nm.

The laser beams employed in this context customarily have powers in the range from 50 W up to 1000 W.

The beam thickness may be adjusted as and when required; spot radii of 15 to 200 μm are customary. By reducing the beam thickness it is possible to obtain smaller structures and higher energy densities of the shaped bodies, and this may extend the duration of a printing procedure.

In one embodiment the power of the beam is set so that there is at least partial transformation of Fe(0) and magnetite into wuestite. The power of the beam in this case is chosen such that the irradiated powder is subjected locally to temperatures at which an at least partial transformation to wuestite can occur. The irradiation customarily generates temperatures in the range up to 1600° C. In one embodiment the temperatures generated are in the region of the Tammann temperature up to the melting point of magnetite.

As a result of the irradiation of the layer in step b), which is optionally repeated multiply, the shaped body is generated, and is subsequently separated from excess, untransformed powder. This is done in a conventional way, such as by sieving or removal of the powder with compressed air, for example.

In one embodiment the pore volume of the shaped catalyst body of the invention is between 5 and 100 mm³/g, preferably between 7 and 70 mm³/g, more preferably between 10 and 40 mm³/g, determined by means of Hg porosimetry according to ASTM-D4282-12.

The side crush strength of the shaped catalyst body is customarily at least 25 N, preferably at least 50 N, more preferably at least 100 N. It is preferably in the range from 25 to 500 N, more preferably in the range from 50 to 400 N, very preferably in the range from 100 to 350 N.

The iron present in the shaped catalyst body of the invention is present primarily in oxidic form, customarily as magnetite or wuestite or a mixture thereof. In one embodiment the fraction of wuestite in the iron compounds of the shaped catalyst body is at least 50 wt %, preferably 80 wt %, more preferably 85 wt %, with greater preference 90 wt %, very preferably 100 wt %. Besides the structures primarily present such as magnetite and/or wuestite, there may also be other iron compounds present as secondary constituents. The fraction of these secondary constituents is customarily below 10 weight %, preferably below 5 weight %, more preferably below 1 weight %.

The fraction of iron compounds in the shaped catalyst body of the invention is in the range from 80.0 to 100.0 wt %, preferably in the range from 80.0 to 99.9 wt %, more preferably in the range from 90 to 99.9 wt %, very preferably in the range from 90.0 to 97.0 wt %, based on the total weight of the shaped catalyst body.

The fraction of the promoters, determined as oxides, in the shaped catalyst body of the invention is customarily 0.1 to 20.0 wt %, preferably 0.1 to 10.0 wt %, more preferably 3.0 to 10.0 wt %, based on the total weight of the shaped catalyst body.

The shaped catalyst body obtainable with the method of the invention may be subjected subsequently to a thermal treatment in order to burn out organic materials such as binders or pore-modifying materials and/or to modify the physicochemical properties. The thermal treatment may be conducted at a temperature in the range from 300 to 1400° C., preferably in the range from 500 to 1200° C.

The shaped catalyst body obtainable with the method of the invention may be subjected subsequently to a reduction step in order to transform the metal compounds into the corresponding metals. This may be done either at room temperature or at elevated temperature, as for example at a temperature in the range from 150 to 800° C., in order to transform reducible metal compounds into the corresponding metals.

In one embodiment the reduction is performed by exposing the shaped catalyst body to a hydrogen-containing gas stream at a temperature in the range from 150 to 800° C., preferably in the range from 150 to 600° C.

The method of the invention is suitable for providing catalysts for ammonia synthesis that have structures which are not accessible by the conventional arc furnace process. In this way it is possible, for example, to produce catalysts as structural units that can be employed in storage media for the storage of energy in the form of ammonia. This opens up possible applications in the area of decentralized energy storage, such as in households, for example, where structured structural units can be used advantageously as a constituent of energy stores. Shaped bodies for structured reactors can be produced, for example. In principle such structures are accessible as represented by the photographs of shaped bodies in different geometries, depicted in FIGS. 1 to 3. Suitable shaped bodies for structured reactors are those as described for example in C. Busse, H. Freund, W. Schwieger, Chemical Engineering and Processing—Process Intensification 2018, 124, 199-214, the relevant disclosure content of which is hereby adopted into the description.

The method of the invention overcomes the disadvantages known from the prior art that affect the commercially employed arc furnace process. Whereas with the arc furnace process the mixture comprising the iron compounds must first be melted and after the cooling procedure the solidified melt must be pelletized, producing pellets of different sizes, with the method of the invention it is possible to stipulate the desired pellet size, and/or in principle shapes other than pellets can be specifically produced.

The shaped catalyst bodies of the invention can be used in ammonia synthesis, in which ammonia is formed from hydrogen and nitrogen. Fields of application in this case are on the one hand the industrial ammonia synthesis, by the Haber-Bosch process, for example. However, the shaped catalyst body may also be used for other fields of use such as, for example, the energy storage of hydrogen in the form of ammonia.

The shaped catalyst bodies of the invention may also be employed in other reactions, such as the Fischer-Tropsch reaction. In the Fischer-Tropsch reaction, synthesis gas (a mixture of CO and H₂) is transformed into a series of hydrocarbons in the form of materials which range normally from gaseous to waxy and water.

### BRIEF DESCRIPTION OF THE FIGURES

FIG. 1 shows a photo of a shaped body structure in the form of a bead having three cylindrical channels which intersect one another orthogonally, an all-round indentation between the channels, and also semicircular indentations on the bead surface.

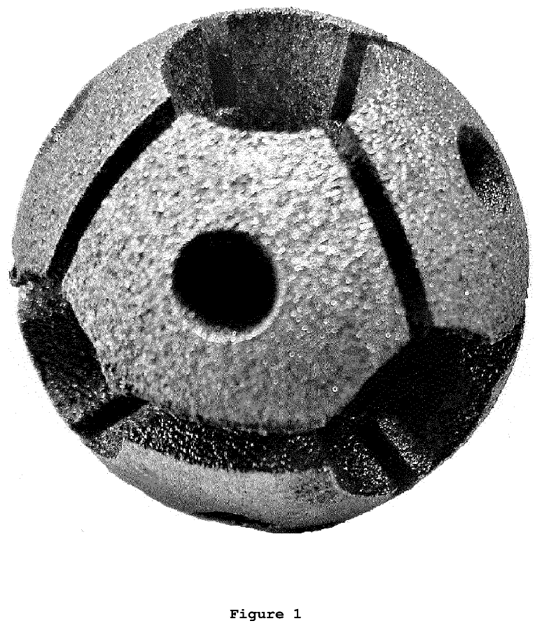

FIG. 2 shows a photo of a shaped body structure in the form of a three-dimensional letter C.

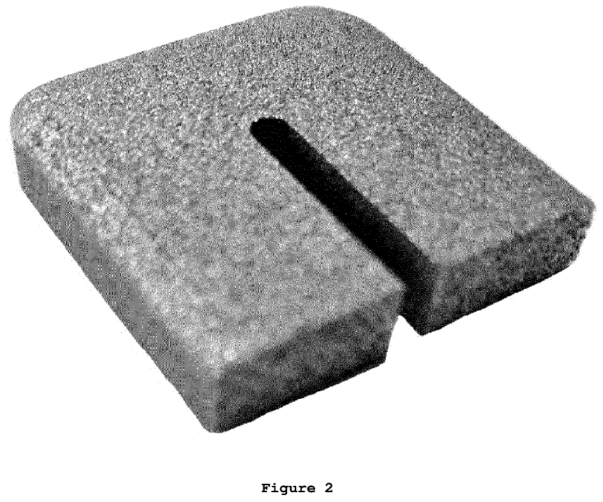

FIG. 3 shows a photo of a shaped body structure in the form of a cylinder having three cylindrical channels which intersect one another orthogonally.

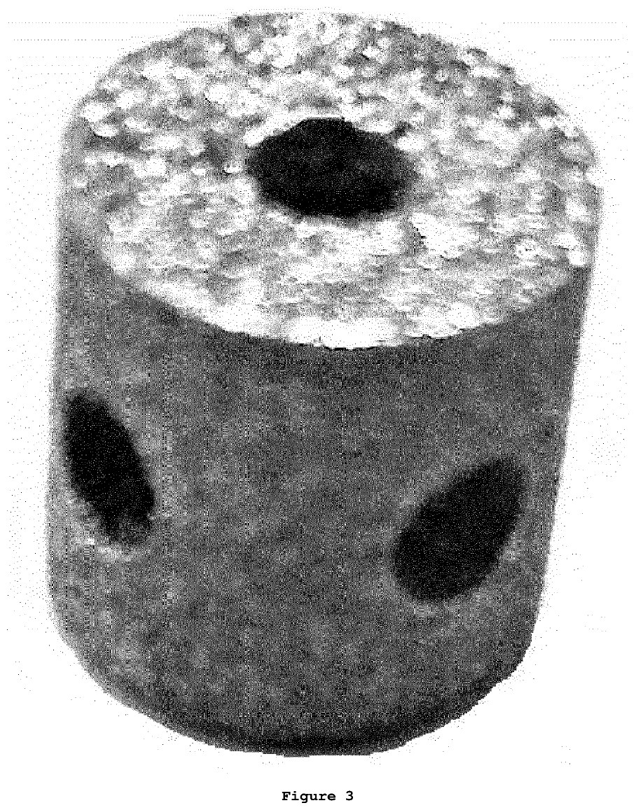

FIG. 4 shows the x-ray powder diffractogram of comparative catalyst 1.

FIG. 5 shows the x-ray powder diffractogram of the inventive catalyst 3.

### EXPERIMENTAL SECTION

### Measurement Methods

### Pore Volume

The pore volume was determined using the PASCAL 440 mercury porosimeter from Thermo Electron Corporation. Measurement took place according to ASTM-D4284-12.

For the conduct of the measurements, the sample was first dried at 60° C. for 16 h. The sample was thereafter evacuated in a dilatometer at room temperature for 30 min (p<0.01 mbar) and filled with mercury. Following insertion into the autoclave of the PASCAL 440, the pressure was slowly increased to up to 4000 barg. The evaluation took place on the assumption of cylindrical pores, a contact angle of 140°, and a mercury surface tension of 480 dyn/cm.

### Side Crush Strength

The side crush strength (SCS) was measured using the Zwick 0.5 instrument from Zwick with a 500N load cell. Evaluation took place using the test Xpert II software. At least 50 individual samples were measured and the average side crush strength was calculated by adding up the individual values and dividing them by the number of samples measured. The side crush strength/diameter (SCSD) was ascertained by first dividing the value of the side crush strength for the respective sample by its diameter. The individual values obtained in this way were added up and divided by the number of samples measured.

### X-Ray Powder Diffractometry

The crystal structures and also their weight fraction in the shaped catalyst body were determined by means of x-ray diffractometry and Rietveld refinement. The sample was measured in a D4 Endeavor from BRUKER over a range from 5 to 90°2Θ (step sequence 0.020°2Θ, 1.5 seconds measuring time per step). The radiation used was CuKα1 radiation (wavelength 1.54060 Å, 40 kV, 35 mA). During the measurement the sample plate was rotated about its axis at a velocity of 30 revolutions per min. The diffractogram of the reflection intensities obtained was subjected to quantitative calculation by means of Rietveld refinement and the fraction of the respective crystal structure in the sample was determined. The fraction of the respective crystal structure was determined using the TOPAS software, Version 6, from BRUKER.

### Elemental Analysis

Chemical elements were determined by means of ICP (inductively coupled plasma) measurement according to DIN EN ISO 11885. Potassium was determined by means of AAS (atomic absorption spectrometry) measurement according to “E13/E14 Deutsche Einheitsverfahren zur Wasser Abwasser and Schlammuntersuchung Band 1, 1985” [E13/E14 unified German methods for water, wastewater and sludge analysis, volume 1, 1985].

### Example 1: Comparative Catalyst 1

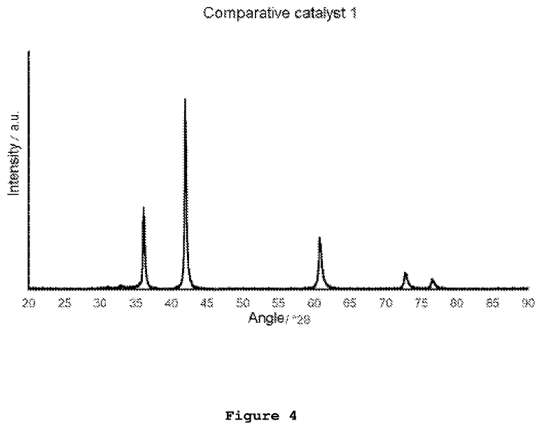

Comparative catalyst 1 was produced by mixing and homogenizing a mixture of magnetite and iron powder in a stoichiometric ratio of 1:1 and then melting it in an arc furnace. When the mixture was fully melted, the melt was cooled in a melting form and the cooled mass was converted to particles by breaking up the material in a jaw crusher. The pore volume was 7.5 ml/g. The x-ray powder diffractogram is shown in FIG. 4.

### Example 2: Comparative Catalyst 2

Comparative catalyst 2 was produced by melting a commercially available magnetite ore in an arc furnace. When the ore was completely melted, the melt was cooled in a melting form and the cooled mass was converted to particles by breaking up the material in the jaw crusher.

### Example 3: Inventive Catalyst 3

The inventive catalyst 3 was produced by mixing and homogenizing a mixture of magnetite and iron powder in a stoichiometric ratio of 1:1 and subjecting the mixture to a three-dimensional printing operation in an M2 printer from ConceptLaser. In this case a layer of the mixture with a layer thickness of 1.5 mm was introduced and was treated with a laser beam at 400 W power so as to give shaped bodies of granular form. After the printing process, the unconnected particles were removed from the printed shaped bodies.

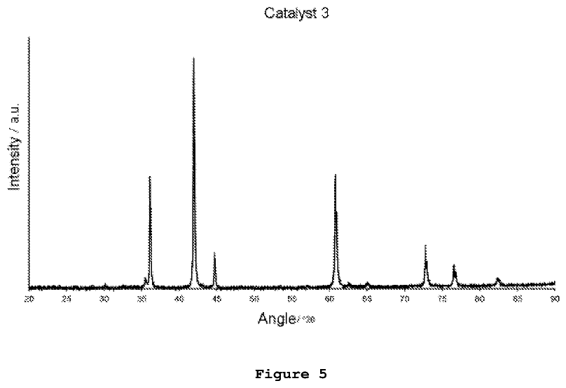

As a result of the production method, the particles were predominantly in the form of wuestite. The pore volume was 16.2 mL/g. The x-ray powder diffractogram is shown in FIG. 5.

### Example 4: Inventive Catalyst 4

The inventive catalyst 4 was produced by mixing and homogenizing a mixture of magnetite and iron powder in a stoichiometric ratio of 1:1 and of Al, K and Ca compounds as promoters and subjecting the mixture to a three-dimensional printing operation in an M2 printer from ConceptLaser. In this case a layer of the mixture with a layer thickness of 1.5 mm was introduced and was treated with a laser beam at 400 W power so as to give shaped bodies of granular form. After the printing process, the unconnected particles were removed from the printed shaped bodies.

As a result of the production method, the particles were predominantly in the form of wuestite.

### Application Example 1

The inventive catalysts 3 and 4 and also the comparative catalysts 1 and 2 were employed in a reaction for ammonia synthesis.

For this reaction, 5 g of catalyst sample in the form of the fraction having a particle diameter of 450 to 550 micrometers were introduced into a reactor and, at a reactor pressure of 90 bar, a gas stream consisting of nitrogen (22.5 volume %), hydrogen (67.5 volume %) and argon (10 volume %) was passed through. The temperature in the reactor interior was raised continuously to 520° C. and maintained at this temperature until the reduction of the catalyst was at an end. The pressure was subsequently increased to 100 bar, cooling took place to a temperature of 400° C., and these conditions were retained for 22 hours. After the 22 hours, the concentration of ammonia formed was detected and the temperature was subsequently raised to 520° C. and retained for 14 hours in order to produce accelerated deactivation of the catalyst. Thereafter the procedure described above (holding of the temperature at 400° C. for 22 h, followed by a temperature increase to 520° C. for 14 h) was repeated twice more (once more for catalyst 4). The results of the ammonia concentrations are summarized in table 2.

| | Ammonia yield per cycle [kg_{NH3}/ | | |
|---|---|---|---|
| | (kg_{catalyst} * h)] | | |
| Catalyst | Cycle 1 | Cycle 2 | Cycle 3 |
| Comparative catalyst 1 | 0.150 | 0.137 | 0.129 |
| Comparative catalyst 2 | 0.063 | 0.037 | 0.00 |
| Catalyst 3 | 0.165 | 0.151 | 0.145 |
| Catalyst 4 | 0.455 | 0.444 | — |

1. A method for producing iron-containing shaped catalyst bodies, comprising the steps of:
a) applying a pulverulent starting material or starting material mixture comprising at least one iron compound in a thin layer to a base,
b) subsequently irradiating this layer at selected sites so that the powder at these sites becomes connected, thereby connecting the powder particles to one another,
c) removing the unconnected powder, so that the connected powder remains in the form of the shaped catalyst body.

2. The method as claimed in claim 1, wherein between step b) and step c)
steps a) and b) are repeated until the shape of the shaped catalyst body has formed.

3. The method as claimed in claim 1, wherein step a) a mixture of Fe in oxidation state 0 and FeO, Fe₂O₃ or Fe₃O₄, preferably a mixture of Fe and Fe₃O₄, is applied.

4. The method as claimed in claim 3, wherein the iron compounds contained in the mixture are transformed at least partially into other iron compounds.

5. The method as claimed in claim 3, wherein the starting material mixture applied is pulverulent Fe(0) and Fe₃O₄ in the form of magnetite and these are transformed at least partially into wuestite.

6. The method as claimed in claim 1, wherein the fraction of wuestite in the iron compounds of the shaped catalyst body obtained is at least 50 wt %, preferably at least 80 wt %, more preferably at least 85 wt %, with greater preference at least 90 wt %, and very preferably 100%.

7. A shaped catalyst body produced by a method as claimed in claim 1.

8. The shaped catalyst body as claimed in claim 7, wherein the fraction of wuestite in the iron compounds of the shaped catalyst body is at least 50 wt %, preferably at least 80 wt %, more preferably at least 85 wt %, with greater preference at least 90 wt %, and very particularly 100 wt %.

9. The shaped catalyst body as claimed in claim 7, wherein it has a pore volume in the range from 10 to 100 mm³/g.

10. A method for ammonia synthesis from hydrogen and nitrogen with a shaped catalyst body produced by a method as claimed in claim 1 6.

11. A method for synthesizing a hydrocarbon mixture from hydrogen and carbon monoxide with a shaped catalyst body produced by a method as claimed in claim 1 6.

12. The method as claimed in claim 11, wherein it comprises a Fischer-Tropsch reaction.
